(19) United States
(12) Patent Application Publication
(10) Pub. No.: US 2018/0138728 A1
(43) Pub. Date: May 17, 2018

(54) PORTABLE CHARGING APPARATUS FOR CHARGING ELECTRONIC DEVICES

(71) Applicants: John Patrick Kefalos, Flemington, NJ (US); Andrew Ryan Griffin, Zanesville, OH (US); Logan Thomas Ross, Fleming, OH (US); Brady Patrick Farrell, Liberty Township, OH (US)

(72) Inventors: John Patrick Kefalos, Flemington, NJ (US); Andrew Ryan Griffin, Zanesville, OH (US); Logan Thomas Ross, Fleming, OH (US); Brady Patrick Farrell, Liberty Township, OH (US)

(21) Appl. No.: 15/810,875

(22) Filed: Nov. 13, 2017

Related U.S. Application Data
(60) Provisional application No. 62/423,367, filed on Nov. 17, 2016.

(51) Int. Cl. H02J 7/00; H02N 2/18

(52) U.S. Cl. CPC H02J 7/0054; H02J 2007/0062; H02N 2/186

(57) ABSTRACT

An apparatus for charging an electronic device is disclosed. The apparatus includes a wearable strap and an energy producing unit embedded in the wearable strap including a removable energy storage unit attached to the wearable strap and in communication with the energy producing unit. The removable energy storage unit has a first side and an opposite second side, the first and second side attached to and detachable from the wearable strap and the first side is configured to plug into multiple external electronic devices enabling the removable energy storage unit to transfer stored energy into the external electronic device for charging the external electronic devices and the first side of the removable energy storage unit communicates with the energy producing unit.

### TECHNICAL FIELD

The present embodiments relate to electronic devices. Specifically, the present embodiments relate to portable charging systems for electronic devices.

### BACKGROUND

Consumers carry multiple portable devices. The batteries in these devices cannot withstand the daily use without requiring some type of charge at least once per day. This results in the need for a wall outlet or a portable charging device.

Many different types of portable electronic devices are currently available including: smart phones, handheld computers, music players and cellular telephones, for example. These portable electronic devices are typically powered by rechargeable power packs, which may include rechargeable batteries, such as rechargeable lithium-ion or nickel cadmium batteries, for example. Rechargeable power packs may be re-charged from a low charge state using a charger that plugs into an electrical wall outlet and the portable electronic device.

It is not always easy or convenient for a user to find an available outlet to charge a device. Devices these days do not possess very efficient batteries, resulting in the need to be charged multiple times per day. Traveling internationally results in having to carry multiple power converters in order to safely charge/power-up a device. In particular, it is difficult to find a convenient source to power a device when traveling. Outlets are difficult to find when in an airport, bus stations or other travel destinations. Portable battery charges eventually have to be recharged.

It would be desirable to provide a portable charging device available to recharge electronic devices without requiring an outlet. Such a portable charging device could have the portability of an external battery while having the capacity to recharge itself.

One such possibility is utilizing piezoelectric material to provide a source of power to recharge the portable charging device. When a piezoelectric material such as lead zirconium titanate (PZT), quartz crystal (SiO2), or zinc oxide (ZnO) is deformed in response to an external force, electrical polarization is induced inside the material, and positive and negative charges appear on the surface. Such a phenomenon is called a piezoelectric effect. There has been proposed an electrical power generation method of vibrating a cantilever to thereby make a weight repeatedly act on the piezoelectric material, and thus taking out the charge generated on the surface of the piezoelectric material as a current using such a characteristic the piezoelectric material has.

Thus, a portable charging device that is continuously recharging itself for later applications to an electronic device would be more convenient for users.

### SUMMARY

An apparatus for charging an electronic device comprising a wearable strap and an energy producing unit embedded in the wearable strap including a removable energy storage unit attached to the wearable strap and in communication with the energy producing unit. The removable energy storage unit has a first side and an opposite second side, the first and second side attached to and detachable from the wearable strap and the first side is configured to plug into multiple external electronic devices enabling the removable energy storage unit to transfer stored energy into the external electronic device for charging the external electronic devices and the second side of the removable energy storage unit communicates with the energy producing unit.

Also disclosed is a method of charging a device, the method includes generating electrical energy by a piezoelectric material and applying the generated energy to a removable energy storage unit configured to plug into multiple external electronic devices. The method further includes, charging a battery contained in the removable energy storage unit, removing the removable energy storage unit and connecting the removable energy storage unit into an external electronic device and charging the electronic device by the removable energy storage unit.

In another embodiment an apparatus for charging an electronic device is disclosed. The apparatus includes a computer interface device and an energy producing unit embedded in the computer interface device and configured to produce electrical energy by a piezoelectric material. Also included in the apparatus is an energy storage unit embedded in the computer interface device and in communication with the energy producing unit and configured to be charged by the energy producing unit.

### DRAWINGS

The following figures set forth embodiments of the invention in which like reference numerals denote like parts. Embodiments of the invention are illustrated by way of example and not by way of limitation in the accompanying figures.

FIG. 1 is a block diagram of an exemplary portable charger system according to present embodiments;

FIG. 2 is a block diagram of an exemplary portable charger system with inset of a piezoelectric material inset according to present embodiments;

FIG. 3 is a block diagram of an exemplary portable charger system applied to a bracelet according to present embodiments;

FIG. 4 is an exemplary circuit inset for applying the charge created by the piezoelectric material to a portable charger according to present embodiments.

FIG. 5 is an exemplary block diagram of an exemplary portable charger according to present embodiments;

FIG. 6 is an exemplary piezoelectric material applicable to the present embodiments;

FIG. 7 is an exemplary circuit according to present embodiments;

FIG. 8 are examples of applications of the charging system according to present embodiments;

FIG. 9 is an exemplary flow chart of a method for charging an electronic device through the movement of the portable charging system;

FIG. 10 is an exemplary game controller employing system and methods of the portable charger according to the present embodiments;

FIG. 11 is an alternate exemplary circuit according to the present embodiments;

FIG. 12 is an exemplary keyboard employing system and methods of the portable charger according to the present embodiments.

### DETAILED DESCRIPTION

The description set forth below in connection with the appended drawings is intended as a description of various configurations and is not intended to represent the only configurations in which the concepts and features described herein may be practiced. The following description includes specific details for the purpose of providing a thorough understanding of various concepts. However, it will be apparent to those skilled in the art that these concepts may be practiced without these specific details. In some instances, well known circuits, structures, techniques and components are shown in block diagram form to avoid obscuring the described concepts and features.

The present subject matter relates to generating an electrical energy generated from a piezoelectric material for charging a battery in which the battery is intended for further charging an electrical device such as a phone, tablet, music player, etc. The mobile equipment may include a suitcase, backpack, portable dolly or other mobile equipment that includes wheels. The descriptions presented herein generally refer to a bracelet the portable charging device carrier. The embodiments described below with respect to a bracelet are intended as examples only to simplify the description of the apparatus and methods presented herein. For example, in the embodiment of a bracelet as is presented herein, as a user walks or runs while wearing the bracelet, the piezoelectric material generates electrical energy which may be used to charge a battery which is then used to charge an electronic device.

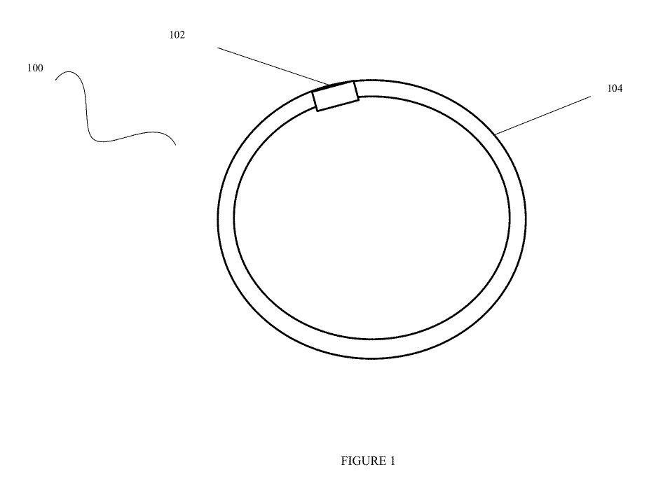

FIG. 1 is an exemplary plain view of an exemplary wearable strap 100 including a portable charging unit 102 attached to a strap or band 104. FIG. 1 is meant as an example only to illustrate embodiments of the invention but is not intended as a limitation of the present subject matter or its implementation. The wearable portable charging device 100 could alternatively be a belt, wrist or arm strap, ankle bracelet, attached to a carrying case or any similar design allowing for motion of the strap 104 for charging the portable charging unit 102 as described further below.

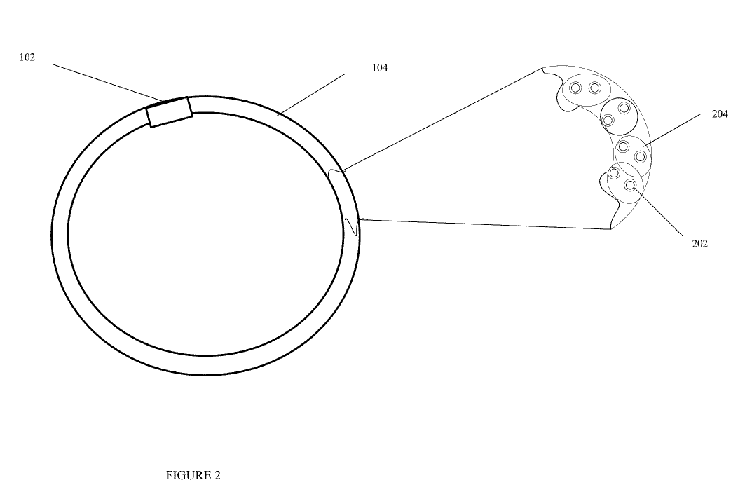

Turning now to FIG. 2, is a block diagram of an exemplary portable charger system with inset of a piezoelectric material inset according to present embodiments is shown. The piezoelectric material 202 is encased in piezoelectric enclosure 204. Strap 104 includes multiple piezoelectric enclosures 204. As a wearer moves the piezoelectric material 202 in the enclosures 204 moved and are thereby energized to produce an electric voltage as will be discussed in more detail below.

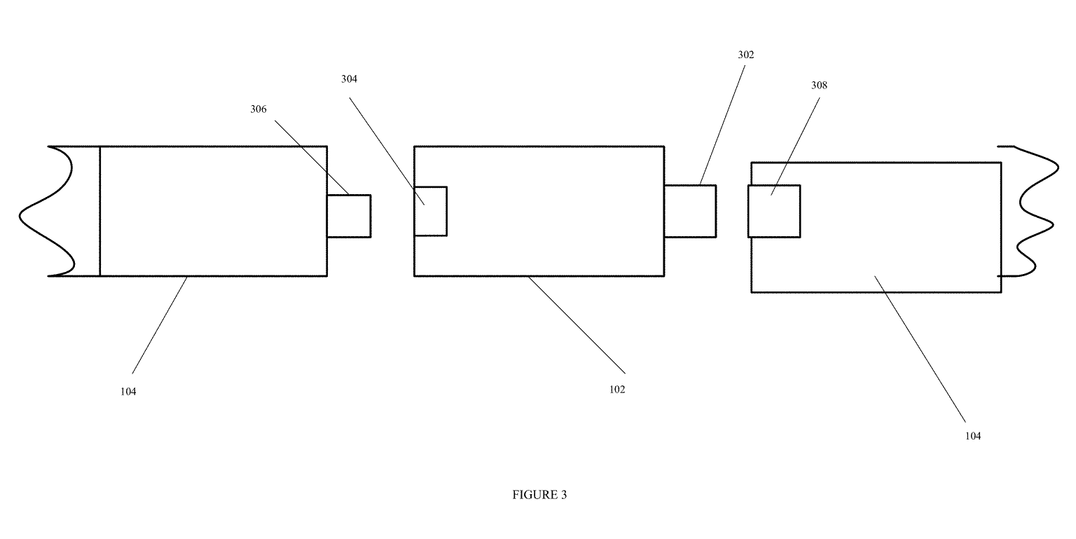

FIG. 3 is a block diagram of an exemplary portable charger system 100 applied to a strap 104 such as a bracelet according to present embodiments. The portable charger system 100 is integrated in a strap 104. In this exemplary view, the portable charging device 102 connects at each end with strap 104. The charging device 102 has a first end 302 and a second end 304. The first end 302 includes, for example, a USB type connector for connecting the charging device to a USB input of an external electronic device for charging the electronic device. The first end 302 may alternatively include any compatible electrical connection system for connecting to an electronic device. The second end 304 is a connection to the strap 104.

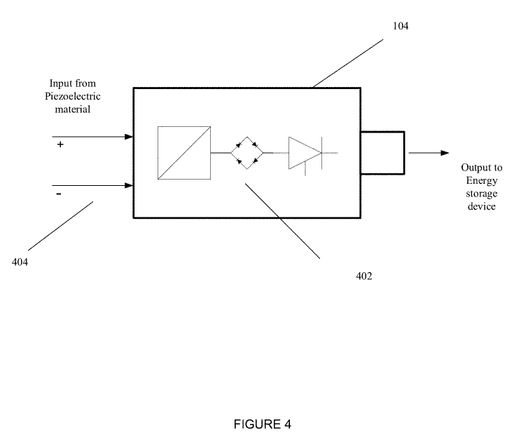

FIG. 4 is an exemplary circuit inset for applying the charge created by the piezoelectric material to a portable charger 104. FIG. 4 represents an exemplary bridge circuit 402 that receives an input of the electrical charge 404 produced by the piezoelectric element 202. The bridge circuit 402 generates an electrical output to the energy storage device 102 to store the electrical charge 404 produced by the Piezoelectric element 202.

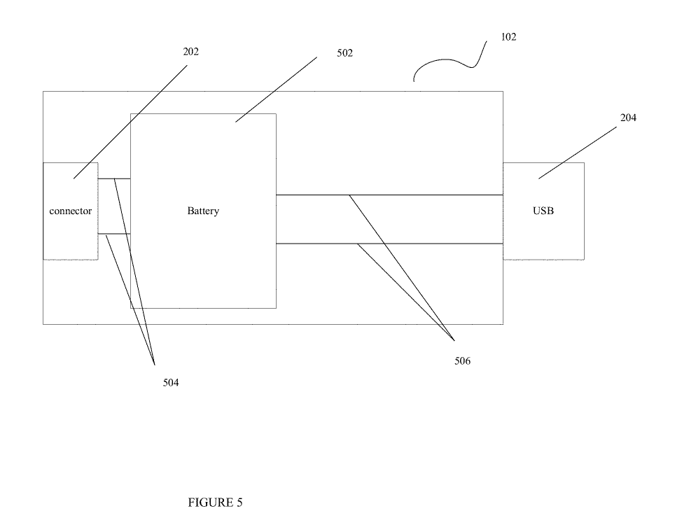

FIG. 5 is an exemplary block diagram of an exemplary portable charger 102. In the exemplary portable charger 102 the connector 302 receives the output of the bridge circuit 402 which generates the electrical output of the piezoelectric element 202. Input lines 504 deliver the electrical output of bridge circuit 402 to the battery 502. Electrical output lines 506 then deliver the electrical output signal to USB connector 204. Connector 204 can alternatively be any type of connector required by the external electrical device. A USB connector is used here only as a non-limiting example to demonstrate the present subject matter but any compatible electrical connection system may be employed by the apparatus disclosed herein.

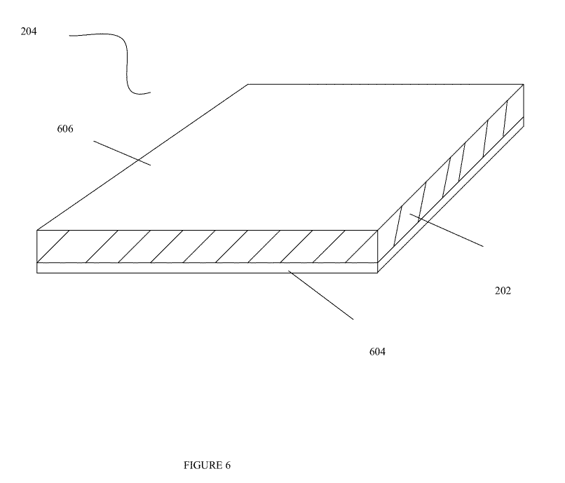

FIG. 6 is an exemplary piezoelectric enclosure 204 applicable to the present embodiments. The piezoelectric enclosure 204 includes a first top portion 606 and a second lower portion 604. Between the first top portion 606 and second lower portion 604 is the piezoelectric element 202. The first top portion 606 and second lower portion 604 may be made of a soft plastic for example capable of containing the piezoelectric element 202 while allowing movement of the piezoelectric element 202 enabling the production of an electrical current as described above.

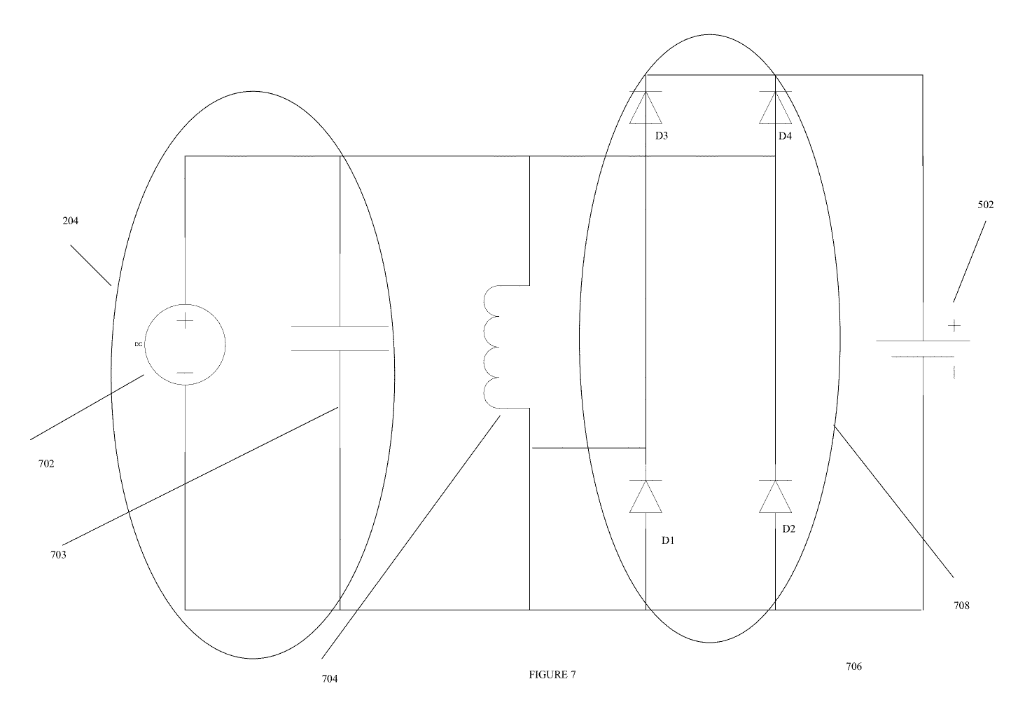

FIG. 7 is an exemplary circuit according to present embodiments. FIG. 7 shows the piezoelectric enclosure 204 with piezoelectric element 202 can electrically be expressed as a current source 702 and a capacitor 703 for storing a charge. An inductor 704 is connected in parallel to the piezoelectric enclosure 204 to thereby form an electrical resonant circuit together with the capacitance component 703 of the piezoelectric element 202. The first electrode and the second electrode provided to the piezoelectric element 202 are connected to a full bridge rectifier 708 composed of four diodes D1 through D4. The diodes D1 through D4 function as the full bridge rectifier 708 for converting the alternating current into the direct current together with the capacitor 703 which is output to batter 504 for charging.

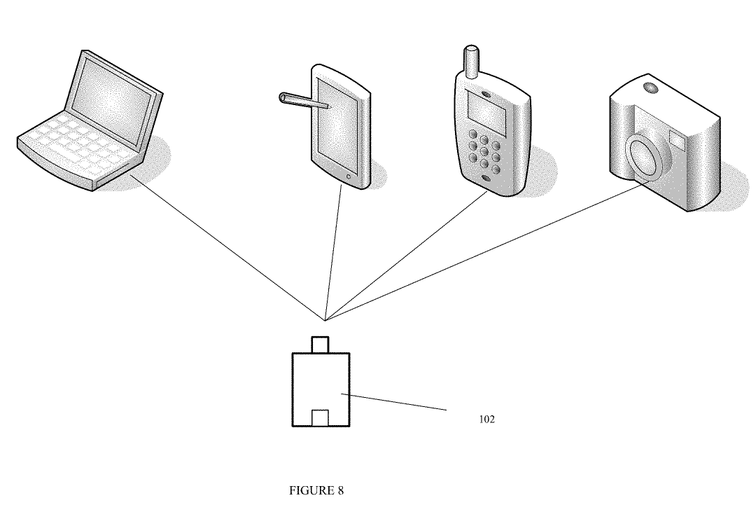

FIG. 8 are examples of applications of the charging system 102 according to present embodiment. Charging system 102 can be used, for example, to charge laptops, tablets, cellphones and cameras as well as other compatible devices.

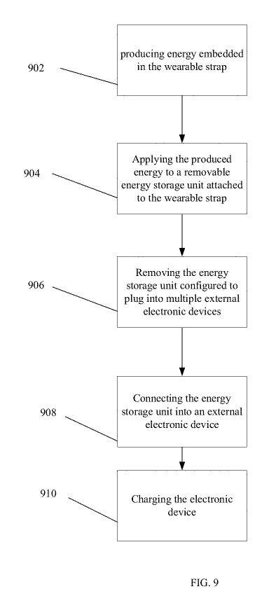

FIG. 9 is an exemplary flow chart of a method for charging an electronic device through the movement of the portable charging system 100. The method starts at step 902 when a movement of piezoelectric element 202 embedded in the charging system 100 of the wearable strap 104 producing energy. At step 904 the produced energy is applied to the removable energy storage unit 102 in the attached to the wearable strap104. At step 906 the energy storage unit 102 is removed and configured to plug into multiple external electronic devices such as shown in FIG. 8. At step 908 the energy storage unit 102 is connected into an external electronic device (FIG. 8). The electronic device is then charged from energy storage unit 102 at step 910.

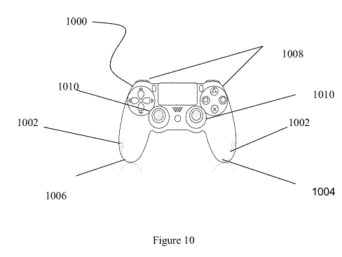

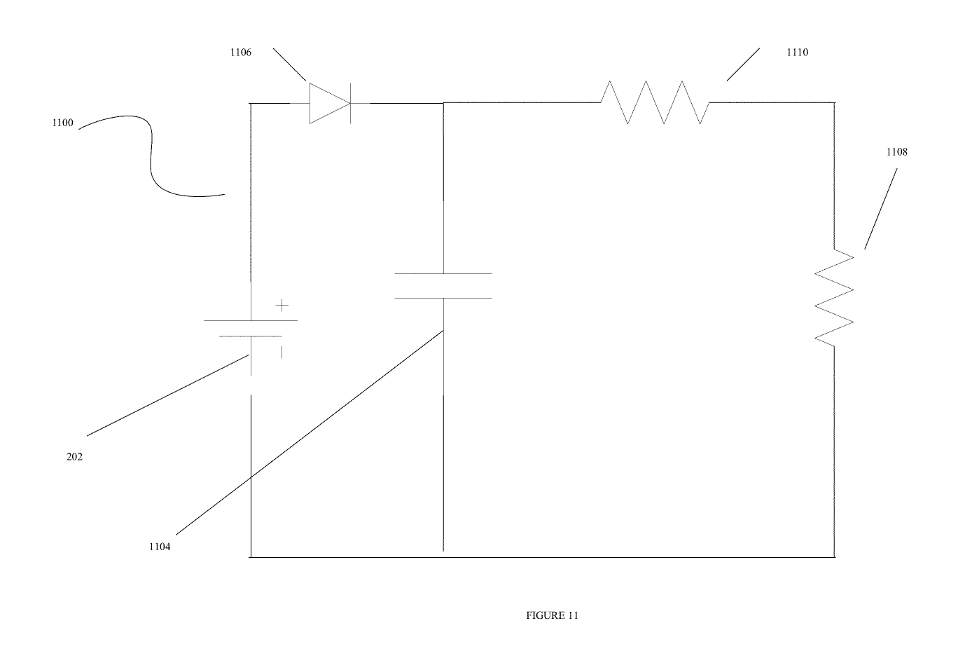

FIG. 10 is an exemplary computer interface device such as a game controller 1000 employing system and methods of the portable charger according to the present embodiments. In the embodiment of FIG. 10 the game controller 1000 includes a piezoelectric enclosures 204 would be placed in pressure nodes 1002, 1008 and 1010 to provide the greatest pressure while playing video games. The piezoelectric enclosures 204 are placed on a first side 1004 and a second side 1006 and underneath the handles of the controller 1008. Another important pressure node the piezoelectric enclosures 204 would be placed would be on the joysticks 1010. In one embodiment, a sleeve (not shown) sliding onto the controller 1000 would provide the piezoelectric enclosures 204 onto the indicated pressures nodes 1002, 1008. 1010. The sleeve is then be plugged into the back of the controller where the charging takes place such as a USB slot. In an exemplary embodiment, controller 1000 with the pressure nodes 1002, 1008, 1010 is not meant to act as a full charger but to help to decrease the rate that the controller discharges. In another exemplary embodiment, a two layer sleeve that would be used to generate electricity. Piezoelectric enclosures 204 are inserted in the top layer and their terminals are inserted in the lower layer. When pressed, the disks generate a charge that is sent into the lower layer of the sleeve via the inserted terminals. The lower layer would be made of a doped silicon that would transmit the electricity generated to a battery or to a terminal. As described the pressure nodes 1002, 1008, 1010 are the places on the controller may generate the highest amount of pressure, resulting in producing the required amount of voltage. As an example, tests indicated the ability to produce approximately 1.7 volts from 20 presses on one piezoelectric enclosures 204 and 4.8 volts on 40 presses. The required voltage needed to charge a controller may be 5 volts. Connecting multiple piezoelectric enclosures 204 within the circuit causes the production of the required power to charge such devices. An exemplary circuit used is shown in FIG. 11

FIG. 11 is an alternate exemplary charging circuit 1100 according to the present embodiments and may, for example, be used in conjunction with the game controller 1000. FIG. 11 represents an exemplary charging circuit 1100 that includes a piezoelectric element 202, a rectifier diode 1106, a 22 μf capacitor 1104, a 2.2 kΩ resistor 1110 and a load 1108. As the piezoelectric element 202 generates a voltage from a pressure as described in FIG. 10, the charging circuit 1100 will produce the voltage out as described in the discussion of FIG. 10.

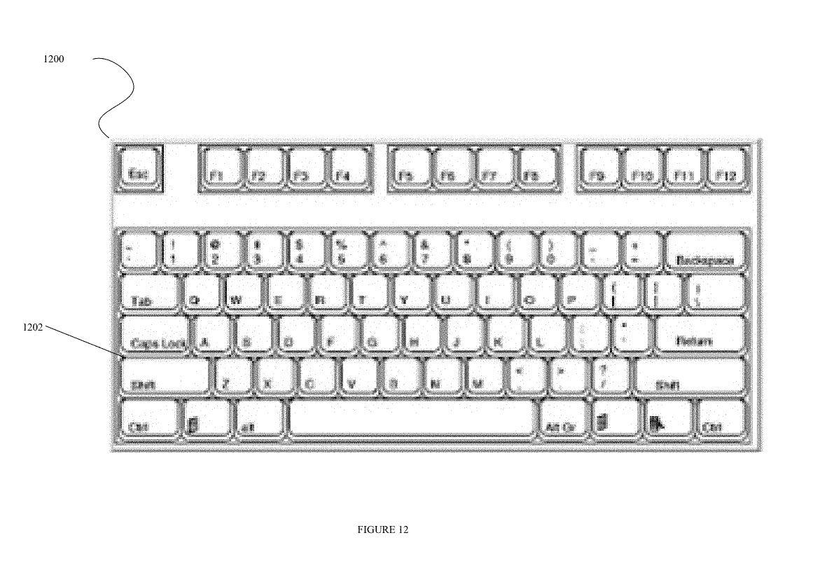

FIG. 12 is an exemplary keyboard 1200 employing system and methods of the portable charger according to the present embodiments. In the embodiment of FIG. 12 the keyboard 1200 includes a piezoelectric enclosures 204 would be placed in pressure nodes 1202 beneath each key of the keyboard. In an exemplary embodiment, keyboard 1200 with the pressure nodes 1202, as in previously discussed embodiments, tests indicated the ability to produce approximately 1.7 volts from 20 presses on one piezoelectric enclosures 204 and 4.8 volts on 40 presses. The required voltage needed to charge a battery, for example, in the keyboard would be 5 volts. Connecting multiple piezoelectric enclosures 204 within the circuit causes the production of the required power to charge such batteries included in computer input devices such as the keyboard or the controller discussed in the exemplary embodiments.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

We claim:

1. An apparatus for charging an electronic device comprising:
a wearable strap;
an energy producing unit embedded in the wearable strap; and
a removable energy storage unit attached to the wearable strap and in communication with the energy producing unit, the removable energy storage unit having a first side and an opposite second side, the first and second side attached to and detachable from the wearable strap, and
wherein the first side is configured to plug into multiple external electronic devices enabling the removable energy storage unit to transfer stored energy into the external electronic device for charging the external electronic devices and the second side of the removable energy storage unit communicates with the energy producing unit.

2. The apparatus of claim 1, wherein the energy producing unit includes piezoelectric material.

3. The apparatus of claim 2, wherein the energy producing unit is configured to produce electrical power from a movement of the piezoelectric material.

4. The apparatus of claim 3, wherein the movement of the piezoelectric material is caused by a movement of the wearable strap.

5. The apparatus of claim 3, wherein the energy producing unit is configured to output the produced energy to the energy storage unit.

6. The apparatus of claim 1, wherein the second side is configured as any compatible connection system.

7. The apparatus of claim 6, wherein the compatible connection system includes a micro USB connection system.

8. The apparatus of claim 1, wherein the energy storage unit includes a rechargeable battery.

9. The apparatus of claim 8, wherein the rechargeable battery includes a lithium battery.

10. The apparatus of claim 1, wherein the energy storage unit is capable of being charged by an external energy source.

11. The apparatus of claim 1, wherein the external electronic devices include a music player, a video player, an entertainment unit, a navigation device, a communications device, a mobile device, a mobile phone, a smartphone, a personal digital assistant, a fixed location terminal, a tablet computer, and/or a laptop computer.

12. A method of charging a device, the method comprises:
generating electrical energy by a piezoelectric material;
applying the generated energy to a removable energy storage unit configured to plug into multiple external electronic devices;
charging a battery contained in the removable energy storage unit; and
removing the removable energy storage unit;
connecting the removable energy storage unit into an external electronic device; and
charging the electronic device by the removable energy storage unit.

13. The method of claim 12, wherein connecting the removable energy storage unit includes connecting through any compatible connection system.

14. The method of claim 13, wherein the compatible connection system includes a Universal Serial Bus (USB) connector.

15. The method of claim 12, wherein the piezoelectric material is embedded in a wrist strap or bracelet.

16. An apparatus for charging an electronic device comprising:
a computer interface device;
an energy producing unit embedded in the computer interface device and configured to produce electrical energy by a piezoelectric material; and
an energy storage unit embedded in the computer interface device and in communication with the energy producing unit and configured to be charged by the energy producing unit.

17. The apparatus of claim 16, wherein the electrical energy produced by the piezoelectric material is caused by a movement of the piezoelectric material.

18. The apparatus of claim 17, wherein the movement of the piezoelectric material is caused by a pressure applied to a pressure node embedded in the computer interface device.

19. The apparatus of claim 16, wherein the computer interface device is a keyboard.

20. The apparatus of claim 16, wherein the computer interface device is a game controller.
